(19) United States
(12) Patent Application Publication
(10) Pub. No.: US 2005/0070342 A1
(43) Pub. Date: Mar. 31, 2005

(54) Under water communication system

(76) Inventor: Kamal Farhat, Marco Island, FL (US)

Correspondence Address: Kamal Farhat, 268 Tahiti Rd., Marco Island, FL, 34145, US

(21) Appl. No.: 10/673,868

(22) Filed: Sep. 29, 2003

(51) Int. Cl. H04M 1/00

(52) U.S. Cl. 455/575.1

(57) ABSTRACT

There is disclosed an under water communication system that consists of three parts. The first part is the sending or transmitting unit that sends a predetermined frequency signal to an under water receiving unit. The under water receiving unit has ear phones attached thereto. Both the receiving unit and the ear phones are water proof contained. There is only a very limited RF or radio frequency that can be used under water and that is a range from 462.0 MHz to 468.0 MHz. Any other frequencies are filtered out and will not be received by the under water receiver. This kind of arrangement will allow a person outside of a pool of water to communicate with persons inside and under water of the pool to teach swimming, for example.

### CROSS REFERENCE TO RELATED APPLICATIONS

(none)

### STATEMENT REGARDING FED SPONSORED R & D

(none)

### BACKGROUND OF THE INVENTION

The invention is involved in an underwater communication system. It is a radio system that operates under water. This communication system is extremely useful, for example, when someone is learning to swim while an instructor is standing on the deck of a pool and while closely observing the progress of the student by giving commands to the student as what to do at any given time. The underwater communication system is also very useful when teaching or supervising any performances in and under water, such as water ballet for group exercises, for example. In order to be precise, it is very important that certain routine commands be followed.

### BRIEF DESCRIPTIONS OF THE INVENTION

The invention consists of a radio sending unit and a an audio receiving unit. It is most important that both units be contained in waterproof housings, especially the receiving unit carried on the body of a swimmer and from there to ear phones on the head of the swimmer.

### BRIEF DESCRIPTION OF THE DRAWINGS

FIG. 1 is a schematic of the FRS receiving unit;

FIG. 2 is a block Diagram of the FRS receiving unit.

### DETAILED DESCRIPTION OF THE INVENTION

### Power Supply

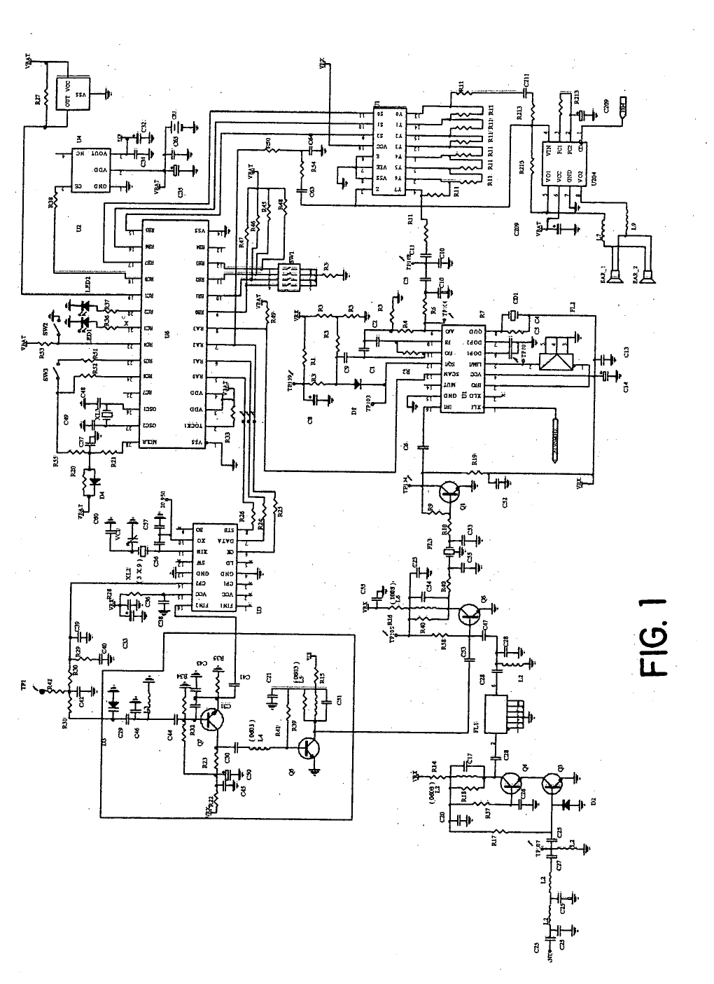

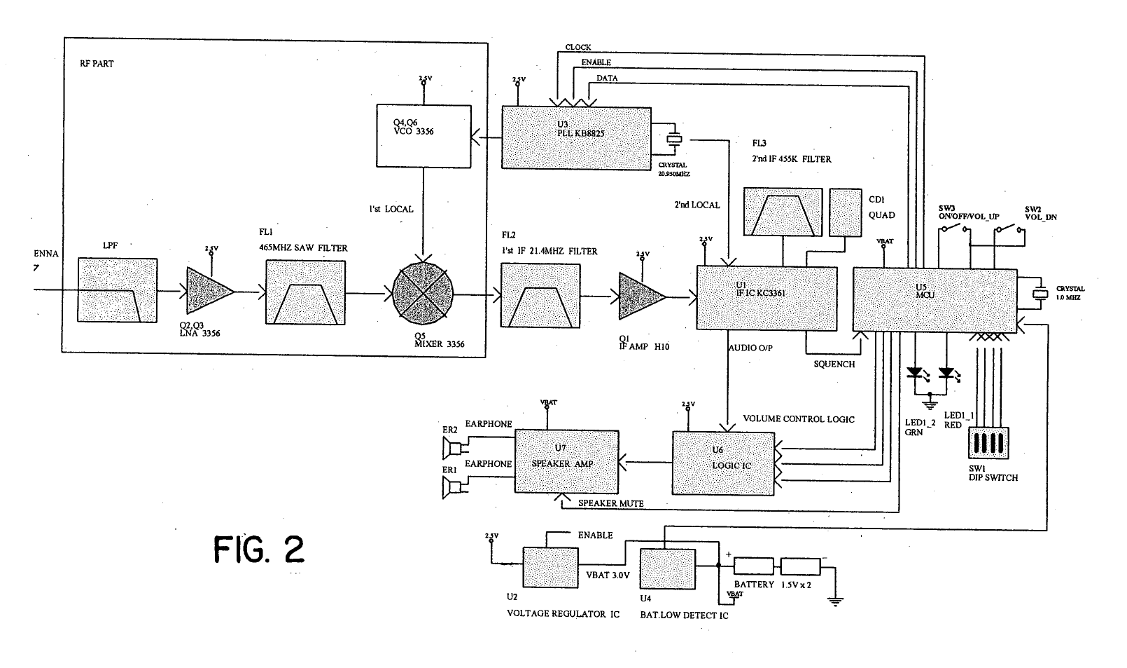

The power for operating the receiver unit is provided by or derived from two AAA size batteries of 1.5 Volts. The battery voltage supply is a 2.5 regulated DC voltage by a U2 regulator IC. The 2.5V is coupled to the RF part as well as the IF part which is shown in greater detail in the schematic diagram (FIG. 1) and the block diagram (FIG. 2). With reference to FIG. 2, the power on/off switch is shown at 3 and U5 MCU controls all of the circuit power. The power switch circuit includes a U2 IC which enables or disables the regulator voltage output. When the “power off” key is pressed and activated which will result in disabling the U2 voltage output and when the “power on” is pressed, this will activate the MCU unit and will enable the U2 voltage output to all circuits.

### Low battery Indicator

When the battery voltage at the U4 IC input terminal detects a voltage below 2.5 V, then U2 provides a low trigger sent to U5 MCU which turns on the LED 1-1 to indicate a low battery state. When the battery voltage above 2.5V appears to provide a higher trigger level to U5 MCU, which will then turn off the LED.

### Radio Frequency Section

The receiver is a double superhet arrangement with a first of 21,4 MHz and a second of IF of 455 MHz. The circuitry of the receiver part is illustrated in greater detail in the schematic of FIG. 1. The receiver antenna is combined with ear phone wire. The radio signal is coupled with the input of a two stage low noise amplifier (LNA), the LPF match network serves to match the impedance of the antenna with the input impedance of LNA, the LNA serves to boost the level of the received 462.0 MHz-468.0 MHz signal from the transmitter unit and provides the amplifier signal to the input of FLI SAW image filter. Throughout many experiences and tests it has been found that the frequency of 462.0 MHz to 468.0 MHz is the only frequency working under water to receive a signal (voice) to properly work under a depth of up to four feet. This reception can be extended to up to seven feet under water if the receiver has an extended antenna. The FL 1 rejects frequencies that are out of range of the 462.0 MHz-MHz 468.0. The FL 1 output is a pure radio signal which is transmitted to a first input of a mixer Q 5. The receiving unit includes a local oscillator Q4, Q5 VCO signal which is coupled with a second input of the second mixer to supply a local oscillator voltage thereto for down converting the received 462.0 MHz-468.0 MHz provided by the FL 1 The local oscillator voltage produced by the VCO Q4, Q5 which is controlled by a U3 PLL synthesis IC. The VCO has a 14 channel frequency, from 483.4 MHz-489.4 MHz which is stabilized by the U3 PLL synthesis IC. The local oscillator voltage produced by VCO 04, Q5 which is controlled by a U3 PLL synthesis IC. The VCO has a 14 channel frequency from 483.4 MHz-489.4 MHz which is stabilized by U3 LL synthesis IC. The CVO is buffered and the output local signal is fed to the first Q5 mixer. Accordingly the Q5 mixer serves to down convert the 462.0 MHz-468.0 MHz signal received from FL 1 with the use of the 483.4 MHz-489.4 MHz local oscillator voltage.

The Q5 single bipolar transistor mixer down converts the signals to 21.4 MHz intermediate frequency (IF) and the signal supplied at an output Q5 mixer which is coupled with FL2 21.4 MHz IF crystal filter, where selectivity is provided by the crystal filter, then the 21.4 MHz signal is amplified by the Q1 IF amplifier's output to U1 IF IC.

The 21.4 signal is amplified by the IF amplifier and is mixed to 455 KHz and filtered by 6-pole ceramic filter before a demodulation. The audio is derived from the filter analog waveform by a 450 KHz discriminator. The frequency reference for U3 PLL is a 20.950 MHz crystal oscillator which is also used for the second local oscillator in U1 IF.

### Audio Section

The audio signal is coupled to U6 8 channel analog multiplexer IC for volume control. The ‘volume up/volume down’ step is controlled by U5 MCU. When pressing the ‘volume up/volume down’ the MCU will send a logic command to change the 8 step audio volume from +6 db to −15 db range. The U6 8 channel analog multiplexer which is controlled by MCU provides the step audio signal to the U7 speaker amplifier at respective outputs to drive two earphones. The ‘speaker mute enable’ or ‘mute disable’ is controlled by MCU which depends on the U1 IF IC output to control the squelch trigger level. If the receiver catches the wanted radio signal, then U51 squelches a trigger change to a high level as well as MCU sends a ‘mute disable’ command to U7 and the earphones will receive an audio signal. The squelch trigger level stays at a low level at a normal scan mode for an incoming signal and then the ‘speaker mute’ enables. The two piece earphone non audio signal will operate when the ‘speaker mute’ mode is enabled.

### SUMMARY

From all of the above it now be seen that the basic system consists of three parts. No 1, the basic sending unit which is not under water which can only send voice commands under a predetermined frequency range that has been determined to be able to operate only under water. No. 2, the receiver unit that can only receive the above determined under water frequency range and which can only operate within a certain depth in the water which has been established at being within four feet. However if an antenna is added to the receiver, the depth range may change to seven feet.

1. An under water communication system comprising a radio signal sending unit located above the water, a receiving unit located under water and earphones connected to said receiving unit to receive the signals coming into said receiving unit, both said receiving unit and said earphones are contained to be waterproof.

2. The under water communication system of claim 1, wherein the RF has to operate in a certain frequency to be operable under water.

3. The under water communication system of claim 2, wherein said RF radio frequency is only operable in a range of 462.0 MHz to 468.0 MHz.

4. The under water communication system of claim 1 including a receiver antenna which is combined with wires leading to said earphones.

5. The under water communication system of claim 1, wherein the LPF “low pass filter” serves to match the impedance of the antenna with the input impedance of the antenna with the input impedance of the LNA “low noise amplifier” to boost the level of the received 462.0 MHz-468.0 MHz signal from the sending unit.
